(19) United States
(12) Patent Application Publication
(10) Pub. No.: US 2007/0198654 A1
(43) Pub. Date: Aug. 23, 2007

(54) Network Server

(75) Inventor: Masayoshi Matsuoka, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/678,419

(22) Filed: Feb. 23, 2007

(30) Foreign Application Priority Data
Feb. 23, 2006 (JP) 2006-46191

(51) Int. Cl. G06F 15/16

(52) U.S. Cl. 709/217

(57) ABSTRACT

A network server connected via a network to a content playback device that requests content. The network server comprises: content information creating means for creating content information including the fine name of the content and a content URI including playback stop position information concerning the content; and recording means for recording the content and the content information. When receiving a request message for requesting content from the content playback device, a processor in the network server retrieves the content requested by the content playback device from the recording means and then sends the retrieved content to the content playback device. When determining that the content playback device has stopped playback of the content, the processor causes the content information creating means to create content information (content information for resuming) having a content URI including playback stop position information concerning the requested content.

### BACKGROUND OF THE INVENTION

1. Field of the Invention

The present invention relates to a network server, and more particularly relates to playback of content data such as moving images.

2. Description of the Related Art

Network servers are known that send content data such as moving images (hereinafter, referred to as “content”) via a network to a personal computer (PC) capable of playing the content. A PC sends, to a network server, a HyperText Transfer Protocol (HTTP) request message based on the HTTP-GET method to request content. After receipt of the HTTP request message, the network server sends the requested content to the PC.

After stopping playback of content on a PC, some users desire to start playback of the content from the position at which the playback was stopped (hereinafter, referred to as “resume playback”). In a known system for response to the demand, a PC sends to a network server an HTTP-GET request message including a RANGE header in which position information for playback of content is designated. After receipt of the HTTP-GET request message, the network server analyzes the content playback position information designated in the RANGE header, and sends to the PC the content from the playback position designated in the RANGE header. This allows the PC to resume playback.

However, the above described method requires that a PC to resume playback of content record the playback position on the content at which the playback should be resumed. Further, since the position at which playback of content should be resumed is recorded in a PC, a user cannot resume playback of the content using a PC other than the PC last used for playback of the content. In other words, PCs that can be used for resuming playback are limited.

An example of this kind of network server is disclosed in Japanese laid-open patent publication 2005-167891. The network server is designed to send an HTTP HEAD request message to a PC at regular intervals while playback of content is paused on the PC. In this way, the network server keeps a TCP connection between the PC and the network server, thereby allowing the playback to be resumed after the PC ends the pause.

Japanese laid-open patent publication 2005-151569 discloses a network server that can be connected to a broadcast channel for television, radio, or the like so as to send, to a PC, content such as moving images and content for television, radio, or the like. Since data for television, radio, or the like can be displayed as content items, the network server can send to a PC not only content such as moving images but also content for television, radio, or the like.

Japanese laid-open patent publication 2004-350043 discloses a system in which, when a PC makes to a network server a request for variable speed playback content data, the network server creates the variable speed playback content data and sends it to the PC. This allows the PC to play the content at a variable speed only by processing the content received from the network server in a manner similar to normal playback of content.

Further, Japanese laid-open patent publication 2004-320752 discloses a network server comprising mapping means for mapping content information on content received via a network to content information on its own content and content access means for accessing content in a predetermined manner by using a unique identifier assigned to each program included in the content information on the content received via the network. This allows a PC capable of playing content to request the network server to send content by using the own content information.

However, none of the inventions described in the above publications 2005-167891 to 2004-320752 shows the concept that a content playback device can resume playback of content without recording the position at which the playback of the content should be resumed.

### SUMMARY OF THE INVENTION

An object of the present invention is to provide a network server that can eliminate the need for a content playback device to record the position at which playback of content should be resumed when sending the content to the content playback device as well as enabling a user to relatively freely select a content playback device for resuming playback of content.

According to an aspect of the present invention, this object is achieved by a network server to be connected via a network to a content playback device that requests content data (hereinafter referred to as “content”) by sending a request message including a content Uniform Resource Identifier (URI) corresponding to the content, the network server comprising: a network interface for sending and receiving data including the content to and from the content playback device; content information creating means for creating content information including a file name of the content; recording means for recording the content and the content information; request receiving means for receiving the request message sent from the content playback device; content retrieving means for retrieving the content or the content information from the recording means based on the request message received by the request receiving means; response sending means for sending, to the content playback device, data including the content retrieved by the content retrieving means as a response message for response to the request message; and control means for controlling each component in the network server.

The content information further includes a content URI including playback stop position information concerning the content.

When receiving, by the request receiving means, a request message for requesting content from the content playback device, the control means causes the content retrieving means to retrieve the content requested by the content playback device from the recording means and then causes the response sending means to send the retrieved content to the content playback device.

When determining that the content playback device has stopped playback of the content sent by the response sending means, the control means causes the content information creating means to create content information (hereinafter referred to as “content information for resuming) having a content URI including playback stop position information concerning the requested content.

With the above described configuration, when the content playback device has stopped playback of a sent content, the control means creates the content information for resuming. Accordingly, when the content playback device makes a request for playback of the content from a last playback stop position, the control means can send the content information for resuming to the content playback device, thereby enabling the content playback device to receive the content information for resuming and send to the network server a content request designating a content URI included in the content information for resuming.

As a result, the control means can retrieve from the recording means the content from the playback stop position corresponding to the content URI included in the content information for resuming and send it to the content playback device. Accordingly, unlike the prior arts, the content playback device does not have to record a playback stop position on a previously requested content. This can reduce the processing load on the content playback device.

Further, when a user makes a request for playback of a previously requested content from the last playback stop position by using a content playback device other than a content playback device last used for requesting the content, the control means sends the content information for resuming to the other content playback device. Thereby, even in such a case, the other content playback device can make, to the network server, a content request designating content playback stop position information. Accordingly, a user can freely select a content playback device to be used for playing a previously requested content from the position at which the playback was last stopped (resuming playback).

Preferably, the network server further comprises connection detecting means for detecting establishment/termination of a TCP connection between the network server and the content playback device, wherein when detecting, by the connection detecting means, termination of a TCP connection between the network server and the content playback device, the control means determines that the content playback device has stopped the playback of the requested content.

Further preferably, when the content playback device makes a request for playback of the requested content from a last playback stop position, the control means causes the content retrieving means to retrieve the content information for resuming from the recording means and then causes the response sending means to send the content information for resuming to the content playback device, and when the content playback device makes a content request designating the content URI included in the content information for resuming, the control means causes the content retrieving means to retrieve, from the recording means, the content from the playback stop position corresponding to the content URI included in the content information for resuming, and causes the response sending means to send the retrieved content to the content playback device.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 shows the network configuration of a PC and a network server connected to the PC according to one embodiment of the present invention;

FIG. 2 shows the internal configuration of the network server; and

FIG. 3 is a flowchart showing the steps of a process to be executed by the network server when playback is resumed,

### DESCRIPTION OF THE PREFERRED EMBODIMENTS

Referring now to the accompanying drawings, an embodiment of the present invention is described. It is to be noted that the following description of preferred embodiment of the present invention has been presented for purposes of illustration and description, and is not intended to be exhaustive or to limit the present invention to the precise form disclosed.

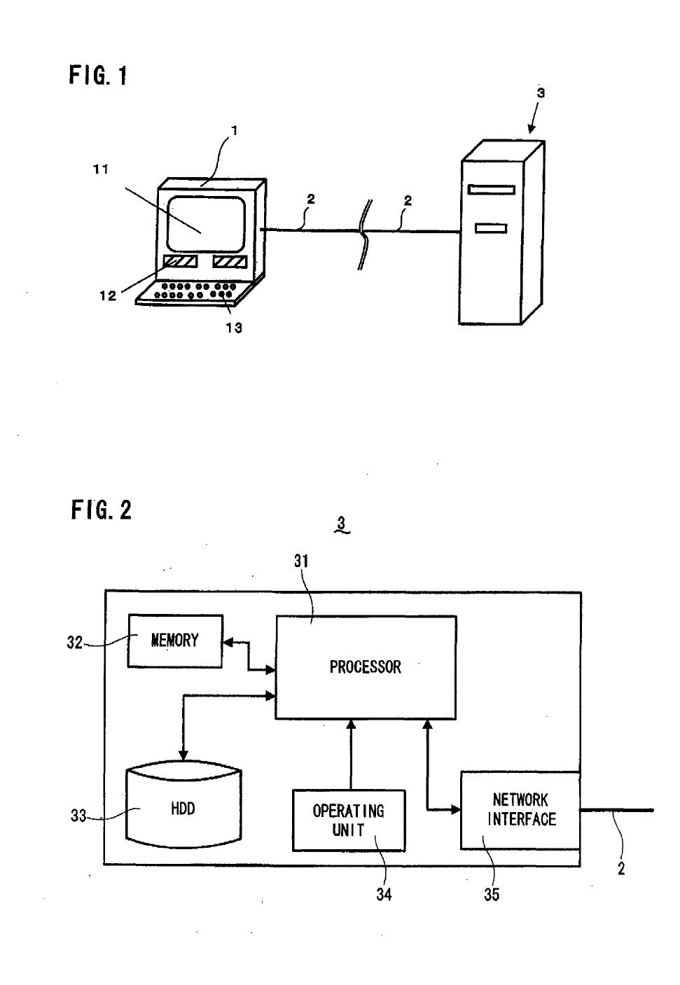

FIG. 1 shows the configuration of a home network including a personal computer (PC) 1, which corresponds to a content playback device in claims, and a network server 3 connected to the PC 1 via a network cable 2. FIG. 2 shows the internal configuration of the network server 3. In the example described here, a content playback device according to the present invention is the PC 1. The PC 1 and the network server 3 are compliant with the UPnP AV (a standard for interconnection of audio/video devices based on Universal Plug and Play specifications).

UPNP compliant devices exchange metadata conforming to eXtensible Markup Language (XML) between them, define as specifications a method for operating each device and a procedure for interaction between them, and operate in accordance with the specifications. Accordingly, there is an advantage that a UPnP compliant device can be easily added to or removed from a network. The network server 3 serves as a device such as a media server based on the UPnP AV specifications as well as serving as a content directory to control, for example, the retrieval of a content list. The PC 1 serves as a control point to, for example, locate content based on the UPnP AV specifications. The PC 1 sends e.g. a Browse command to the content directory in the network server 3.

The PC 1 comprises a network interface (not shown) to be connected to the network cable 2, a display 11 to show various kinds of information to a user, a speaker 12 for audio output, and an operating unit 13 having buttons and the like to be operated by a user.

The PC 1 can request content data such as moving images (hereinafter, referred to as content) by sending a HyperText Transfer Protocol (HTTP) request message based on the HTTP-GET method via the network cable 2 to the network server 3. Then, the PC 1 can receive the requested content from the network server 3 to output the video and audio of the content to the display 11 and the speaker 12. It is to be noted that the PC 1 can include a content Uniform Resource Identifier (URI) corresponding to the requested content in the HTTP request message (which is described later in detail).

As shown in FIG. 2, the network server 3 comprises: a network interface 35 to send and receive content and other data to and from the PC 1; a hard disk 33 (hereinafter referred to as an HDD, which corresponds to recording means in claims) on which content is recorded together with content information including information such as the file name and file size of the content; an operating unit 34 having buttons and the like to be operated by a user; a processor 31 to control each component in the network server; and a memory 32 to store operation programs for the processor 31.

The processor 31 serves as: request receiving means for receiving an HTTP request message sent from the PC 1; content retrieving means for retrieving content or content information from the HDD 33 based on the HTTP request message received by the request receiving means; response sending means for sending to the PC 1 data such as the content retrieved by the content retrieving means as an HTTP response message for response to the HTTP request message; connection detecting means for detecting establishment/termination of a TCP connection between the network server 3 and the PC 1; and content information creating means for creating content information further having a content URI including playback stop position information concerning the content so as to record the created content information on the HDD 33. Further, the processor 31 serves as a content directory based on the UPnP AV specifications and as an HTTP server for sending and receiving various HTTP messages.

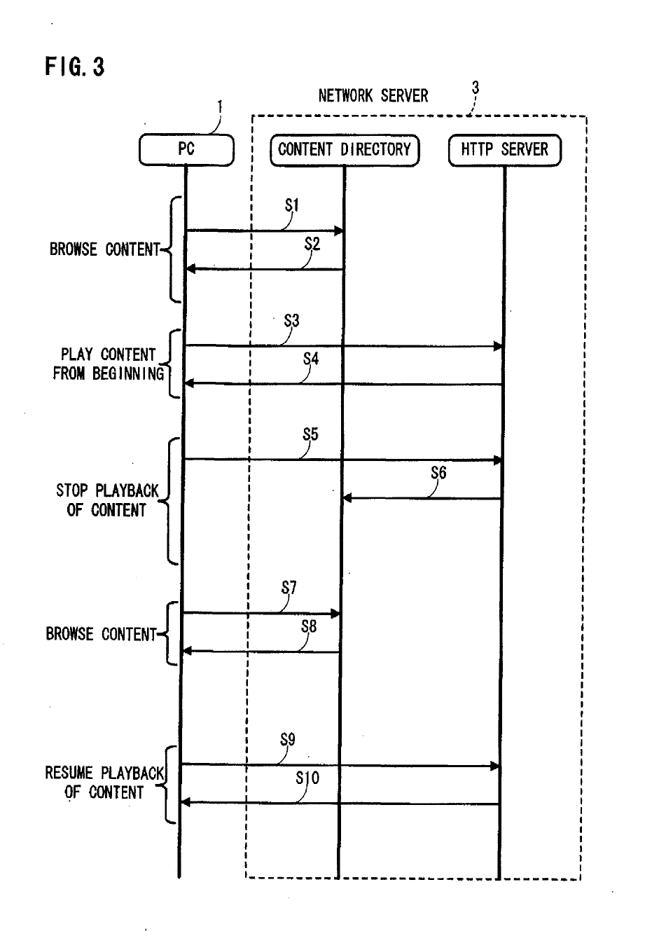

Referring now to FIG. 3, it is described how the network server 3 operates when receiving, from the PC 1, a request for playback of content from the position at which playback of the content was last stopped (hereinafter referred to as “resume playback”). First, a user operates the operating unit 13 on the PC 1 to send to the network server 3 a request for content information concerning content recorded on the HDD 33 (S1). After receipt of the request, the processor 31 sends the content information recorded on the HDD 33 to the PC 1 (S2).

After receipt of the content information from the network server 3, the PC 1 displays the content information on the display 11. When the user selects playback of content by operating the operating unit 13, the PC 1 sends a request for establishment of a TCP connection to the network server 3. After the TCP connection is established between the PC1 and the network server 3, the PC 1 sends to the network server 3 an HTTP request message to request the content (S3). After receipt of the HTTP request message sent from the PC 1, the processor 31 retrieves the content requested by the PC 1 from the HDD 33 and then sends the retrieved content to the PC 1 (S4).

The PC 1 reproduces the content received from the network server 3 and outputs the video and audio to the display 11 and the speaker 12, respectively. While the received content is played on the PC 1, the user can stop the playback of the received content by operating the operating unit 13. When the playback is stopped, the TCP connection between the PC 1 and the network server 3 is terminated (S5).

When the processor 31 detects the termination of the TCP connection between the network server 3 and the PC 1, it determines that the PC 1 has stopped the playback of the requested content. The processor 31 then creates content information having a content URI including playback stop position information concerning the content requested by the PC 1 (hereinafter referred to as “content information for resuming”), and records it on the HDD 33 (S6).

Subsequently, when the user sends to the network server 3 a request for content information recorded on the HDD 33 by operating the operating unit 13 on the PC 1 (S7), the processor 31 sends to the PC 1 the content information for resuming that is recorded on the HDD 33 (S8).

After receipt of the content information for resuming sent from the network server 3, the PC 1 displays the content information for resuming on the display 11. When the user operates the operating unit 13 to select playback of the same content as the content requested at the above step S3 from the position at which the playback of the content was last stopped, the PC 1 sends a request for establishment of a TCP connection to the network server 3. After the TCP connection is established between the PC 1 and the network server 3, the PC 1 sends to the network server 3 a content requesting HTTP request message in which the content URI included in the content information for resuming is designated. (S9).

After receipt of the above request for the content, the processor 31 retrieves from the HDD 33 the content from the playback stop position designated in the content URI included in the content information for resuming, and sends the retrieved content to the PC 1 (S10).

The PC 1 then receives the content sent from the network server 3. Since the received content is one from the position at which playback of the content was last stopped, the PC 1 can easily resume the playback of the content.

Now, the content information and the content URI included in the content information for resuming, which are mentioned above, are described in detail. The content information is metadata represented using the DIDL-Lite Schema according to the XML. The PC 1 obtains the content URI corresponding to content by receiving DIDL-Lite information from the network server 3 and analyzing the received DIDL-Lite information. Rules for assignment of a URI are exemplified below. It is to be noted that rules for assignment of a URI are not limited to the example described below. The following is an example designating a content playback position by byte, which is described in Backus-Naur Form (BNF).

bytePlay=filename “!byte” first-pos“˜” [time-pos] (format of content URIs)

filename=(file name with no designation of playback position)

first-pos=1*DIGIT (byte position for start of playback)

last-pos-1*DIGIT (byte position for end of playback)

In the above example, when playback of content whose file name is “abed.mpeg” is to be started from a position 1000 bytes from the beginning of the content, the content URI is “abcd.mpeg!byte1000˜”. In the case where playback of the content is to be started from a position 1000 bytes from the beginning of the content and ended at a position 2000 bytes from the beginning, the content URI is “abcd.mpeg!byte 1000˜2000”.

The following is another example designating a content playback position by time, which is described in BNF.

timePlay=filename “!time” time-pos “˜” [time-pos] (format of content URIs)

filename=file name with no designation of playback position

time-pos=time-sec|time-hhmmss (designate a time)

time-sec=1*DIGIT (designate a second)

time-hhmmss=time-hh “_” time-mm “_” time-ss[“.” 1*3DIGIT](designate an hour, minute, second)

time-hh=1*DIGIT (designate an hour)

time-mm=1*2DIGIT; 0-59 (designate a minute)

time-ss=1*2DIGIT; 0-59 (designate a second)

In the above example, when playback of content whose file name is “abcd.mpeg” is to be started from a position 60.5 seconds after the beginning of the content, the content URI is “abed.mpeg!time60.5˜”. In the case where playback of the content is to be started from a position 60.5 seconds after the beginning of the content and ended at a position 120 seconds after the beginning, the content URI is “abcd.mpeg!time 60.5˜120”. In the case where playback of the content is to be started from a position 1 hour 30 minutes 29.3 seconds after the beginning of the content, the content URI is “abcd.mpeg!time1_{—}30_{—}29.3˜”. In the case where playback of the content is to be started from a position 1 hour 30 minutes 29.3 seconds after the beginning of the content and ended at a position 2 hours after the beginning, the content URI is “abcd.mpeg!time1_{—}+_{—}29.3˜2_{—}00_{—}00”.

Further, in the case where the URI of the network server 3 relative to an HTTP server is “http://192.168.0.27:30001” and where playback of content whose file name is “abcd.mpeg” is to be started from a position 30 minutes after the beginning of the content, the content URI included in the content information for resuming is “http://192.168.0.27:30001/abcd. mpeg!time0_{—}30_{—}0˜”.

According to the above described embodiment, when the PC 1 stops playback of content, the processor 31 creates content information for resuming concerning the content. Subsequently, when the PC 1 makes a request for playback of the content from the last playback stop position, the processor 31 sends the content information for resuming to the PC 1. After receiving the content information for resuming, the PC 1 can send a content request that designates the position at which the playback is to be resumed by the content URI included in the content information for resuming.

In response, the processor 31 can retrieve from the HDD 33 the content from the position designated by the content URI included in the content information for resuming, and send it to the PC 1. Accordingly, unlike the prior arts, there is no necessity for the PC 1 to record a playback stop position concerning a previously requested content. Thus, the processing load on the PC 1 can be reduced.

Moreover, when a user makes a request for playback of content from the position at which playback of the content was last stopped by operating a PC other than the PC 1 last used for requesting the content, the processor 31 sends content information for resuming to the user operated PC. Therefore, even in such a case, the operated PC can make a content request designating information on the position at which playback of the content was last stopped (i.e., position at which playback of the content should be resumed). Accordingly, a user can almost freely select a PC to be used for playback of content from a last playback stop position (resuming playback).

The present invention has been described above using a presently preferred embodiment, but those skilled in the art will appreciate that various modifications are possible. For example, in the above described embodiment, the PC is used as the content playback device in claims. The content playback device is not limited to a PC but can be other device that is compliant with the UPNP AV standard and capable of playing content received via a network.

This application is based on Japanese patent application 2006-46191 filed Feb. 23, 2006, the contents of which are hereby incorporated by reference.

What is claimed is:

1. A network server to be connected via a network to a content playback device that requests content data (hereinafter referred to as “content”) by sending a request message including a content Uniform Resource Identifier (URI) corresponding to the content, the network server comprising:
a network interface for sending and receiving data including the content to and from the content playback device;
content information creating means for creating content information including a file name of the content;
recording means for recording the content and the content information;
request receiving means for receiving the request message sent from the content playback device;
content retrieving means for retrieving the content or the content information from the recording means based on the request message received by the request receiving means;
response sending means for sending, to the content playback device, data including the content retrieved by the content retrieving means as a response message for response to the request message; and
control means for controlling each component in the network server,
wherein the content information farther includes a content URI including playback stop position information concerning the content,
wherein when receiving, by the request receiving means, a request message for requesting content from the content playback device, the control means causes the content retrieving means to retrieve the content requested by the content playback device from the recording means and then causes the response sending means to send the retrieved content to the content playback device, and
wherein when determining that the content playback device has stopped playback of the content sent by the response sending means, the control means causes the content information creating means to create content information (hereinafter referred to as “content information for resuming) having a content URI including playback stop position information concerning the requested content.

2. The network server according to claim 1, further comprising connection detecting means for detecting establishment/termination of a TCP connection between the network server and the content playback device,
wherein when detecting, by the connection detecting means, termination of a TCP connection between the network server and the content playback device, the control means determines that the content playback device has stopped the playback of the requested content.

3. The network server according to claim 2,
wherein when the content playback device makes a request for playback of the requested content from a last playback stop position, the control means causes the content retrieving means to retrieve the content information for resuming from the recording means and then causes the response sending means to send the content information for resuming to the content playback device, and
wherein when the content playback device makes a content request designating the content URI included in the content information for resuming, the control means causes the content retrieving means to retrieve, from the recording means, the content from the playback stop position corresponding to the content URI included in the content information for resuming, and causes the response sending means to send the retrieved content to the content playback device.

4. The network server according to claim 1,
wherein when the content playback device makes a request for playback of the requested content from a last playback stop position, the control means causes the content retrieving means to retrieve the content information for resuming from the recording means and then causes the response sending means to send the content information for resuming to the content playback device, and
wherein when the content playback device makes a content request designating the content URI included in the content information for resuming, the control means causes the content retrieving means to retrieve, from the recording means, the content from the playback stop position corresponding to the content URI included in the content information for resuming, and causes the response sending means to send the retrieved content to the content playback device.
